(19) United States
(12) Patent Application Publication
(10) Pub. No.: US 2024/0322481 A1
(43) Pub. Date: Sep. 26, 2024

(54) WATERPROOF CABLE CONNECTOR

(71) Applicant: Neptune Technology Group Inc., Tallassee, AL (US)

(72) Inventors: Randall McClay Stoves, Auburn, AL (US); James Michael Beam, Montgomery, AL (US)

(21) Appl. No.: 18/496,322

(22) Filed: Oct. 27, 2023

Related U.S. Application Data
(60) Provisional application No. 63/491,327, filed on Mar. 21, 2023.

(51) Int. Cl. H01R 13/52; H01R 13/625

(52) U.S. Cl. CPC H01R 13/5219; H01R 13/625

(57) ABSTRACT

A connector assembly for connecting a first electrical cable to a second electrical cable includes a first component assembly comprising a first component primary housing, a first conductor assembly, and a first seal member and a second component assembly comprising a second component primary housing, a second conductor assembly, and a second seal member. The first component primary housing is configured to receive the second component primary housing therein when the second component is coupled to the first component. The first seal member provides an axial seal between the first component primary housing and the second component primary housing and the second seal member provides a radial seal between the first component primary housing and the second component primary housing when the second component primary housing is seated within the first component primary housing.

### CROSS-REFERENCE TO RELATED APPLICATION

The present application claims priority to U.S. Provisional Patent Application No. 63/491,327 filed Mar. 21, 2023, the entirety of which is hereby incorporated by reference herein.

### BACKGROUND

The present application relates generally to electrical connectors, and specifically to weatherproof connectors for electrical cables.

Electrical cable connections are widely used to conduct radio frequency signals between electrical devices. To protect such devices from damage in outdoor or high moisture environments, it is important to prevent the ingress of moisture into any cable connection interfaces. Moisture can corrode the cable parts, and also close or short a circuit between the inner connector and the conducting shield. Attempts have been made to develop waterproof connectors. However, such connectors typically require the assembly of multiple parts and the use of specialized tools to establish a reliable and waterproof connection.

### BRIEF DESCRIPTION OF THE DRAWINGS

FIG. 1A illustrates a side plan view of an embodiment of a disconnected connector assembly consistent with implementations described herein;

FIGS. 1B and 1C illustrate first and second perspective views of the connector assembly of FIG. 1A;

FIG. 2A illustrates a side plan view of the connector assembly of FIG. 1A in a connected configuration;

FIGS. 2B and 2C illustrate first and second perspective views of the connected connector assembly of FIG. 2A;

FIG. 3A illustrates the plug component assembly of FIG. 1A in an exploded first plan view;

FIG. 3B illustrates an exploded first cross-sectional view of the plug component assembly of FIG. 3A taken along the line A-A in FIG. 3A;

FIG. 3C illustrates the plug component assembly of FIG. 3A in an exploded second plan view (taken 90° relative to the first plan view of FIG. 3A);

FIG. 3D illustrates an exploded second cross-sectional view of the plug component assembly of FIG. 3A taken along the line B-B in FIG. 3C;

FIG. 4 illustrates an enlarged cross-sectional view and corresponding detail views of the plug component assembly of FIG. 3A in a pre-coupled configuration;

FIGS. 5A, 5B, and 5C are exploded cross-sectional, assembled cross-sectional, and isometric views, respectively, of the plug component assembly of FIG. 3A and an associated dust plug consistent with implementations described herein;

FIG. 6A illustrates the socket component assembly of FIG. 1A in an exploded first plan view;

FIG. 6B illustrates an exploded first cross-sectional view of the socket component assembly of FIG. 6A taken along the line A-A in FIG. 6A;

FIG. 6C illustrates the socket component assembly of FIG. 6A in an exploded second plan view (taken 90° relative to the first plan view of FIG. 6A);

FIG. 6D illustrates an exploded second cross-sectional view of the socket component assembly of FIG. 6A taken along the line B-B in FIG. 6C;

FIG. 7 illustrates an enlarged cross-sectional view of the socket component assembly of FIG. 6A in a pre-coupled configuration; and

FIGS. 8A, 8B, and 8C are exploded cross-sectional, assembled cross-sectional, and isometric views, respectively, of the socket component assembly of FIG. 6A and an associated dust cap consistent with implementations described herein.

### DETAILED DESCRIPTION OF THE PREFERRED EMBODIMENTS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

An electrical connector assembly is disclosed that provides a watertight seal between plug and socket housings (also referred to as male and female housings, respectively) and associated electrical cables. As described below, the connector assembly provides a watertight connection in a single assembly by use of a series of elastomeric bodies between the respective plug and socket housings and a potting material for sealing electrical cables within the respective housings. The connector assembly prevents the infiltration of moisture and can be assembled in a single step without specialized tools. As used herein, the terms “watertight” and “waterproof” refer to the ability to exclude water under approximately atmospheric pressure. Some embodiments of the connector provide a watertight seal under higher pressures, such as those found in submerged environments. Such higher pressures may include (but are not limited to) 1 kilopascal (kPa), 3 kPa, 10 kPa, 100 kPa, 1 megapascal (MPa), 10 MPa, 30 MPa, 60 MPa, 100 MPa, 1000 MPa, approximately (+10%) any of the foregoing, any range between the foregoing, and at least any of the foregoing.

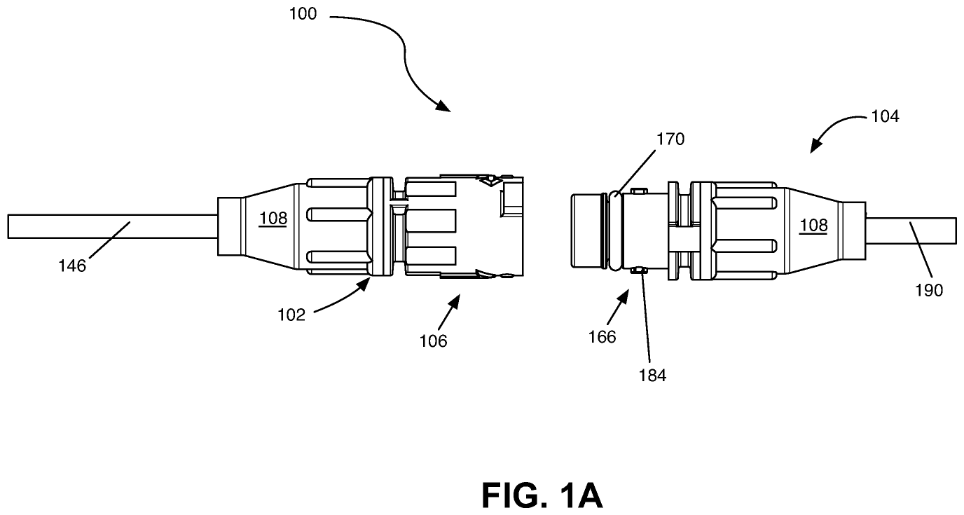

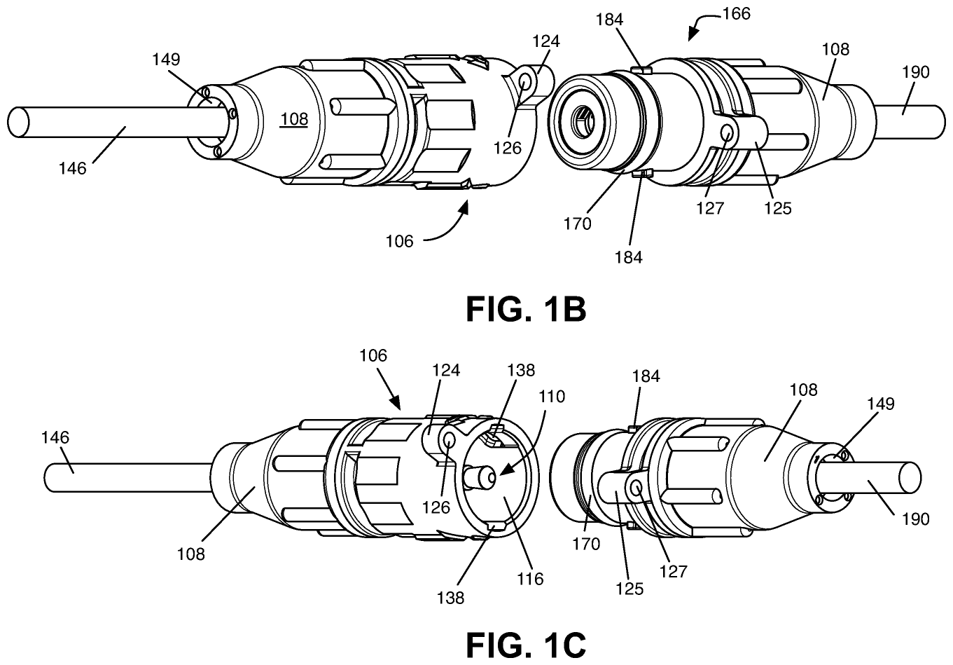

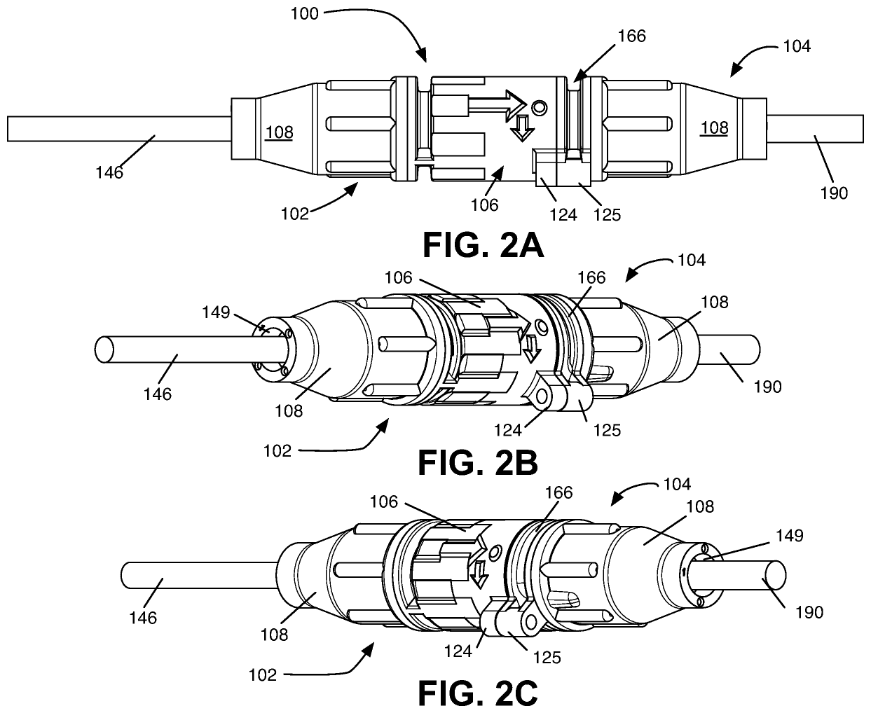

FIGS. 1A-2C provide various views of an embodiment of a connector assembly 100 consistent with implementations described below. As generally shown in FIGS. 1A-2C, connector assembly 100 includes a plug component assembly 102 and a socket component assembly 104 configured to mate together in a sealed, watertight manner. In particular, FIGS. 1A-1C illustrate a disconnected connector assembly 100 in a first isometric view, a second isometric view, and a plan view, respectfully. FIGS. 2A-2C illustrate a connected connector assembly 100 in a first isometric view, a second isometric view, and a plan view, respectfully.

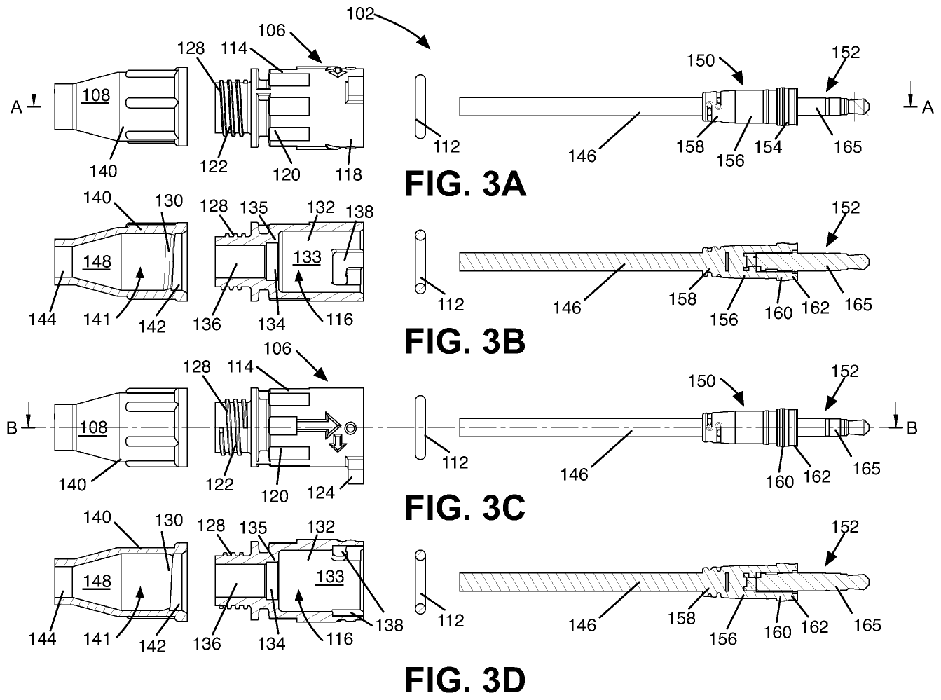

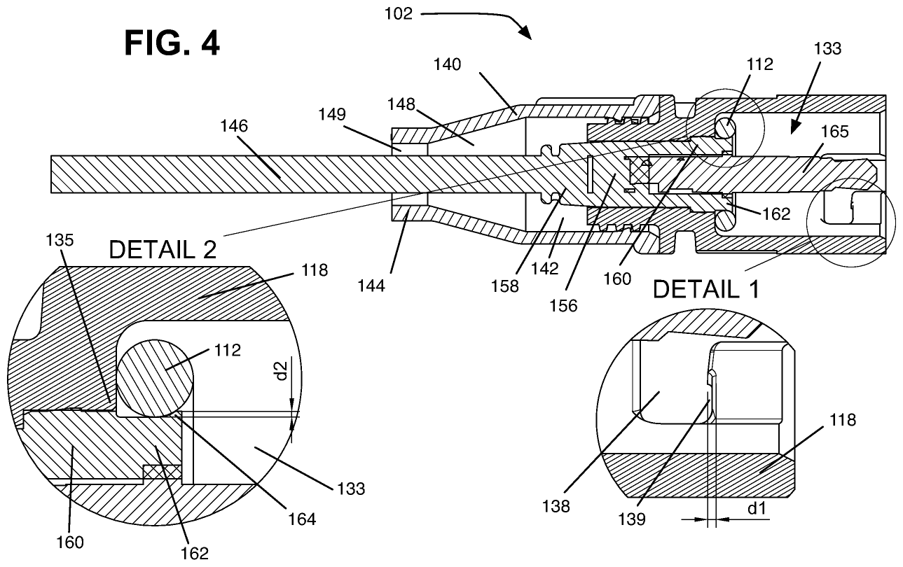

FIGS. 3A-3D illustrate plug component assembly 102 in an exploded first plan view, an exploded first cross-sectional view taken along the line A-A in FIG. 3A, an exploded second plan view (taken 90° relative to the first plan view), and an exploded second cross-sectional view taken along the line B-B in FIG. 3C, respectively. FIG. 4 illustrates an enlarged cross-sectional view and corresponding detail views of plug component assembly 102 in a pre-coupled configuration.

As shown in the various figures and, in particular, FIGS. 3A-3D, plug component assembly 102 includes a primary housing 106, a base housing 108, a plug assembly 110, and a seal member 112. In one implementation, as shown in FIGS. 3A-3D, plug component primary housing 106 include an elongated, generally cylindrical body 114 having a central lumen 116 extending therethrough. Consistent with implementations described herein, primary housing 106 may be made from plastic, metal, or any suitable material or combination of materials. In one specific embodiment, primary housing 106 is molded of a glass fiber reinforced polybutylene terephthalate (PBT) material, although other suitable materials and manufacturing techniques may be used. Primary housing 106 includes a forward end 118 for engaging a corresponding forward end of socket component assembly 104 during coupling of plug component assembly 102 to socket component assembly 104 (described below), an intermediate portion 120, and a rearward end 122 configured to engage base housing 108. As shown most clearly in FIGS. 1B, 2B, and 3B, forward end 118 may include a locking security tab 124 which projects radially from body 114 and is configured to align with a similar security tab 125 on socket component assembly 104 when connector assembly 100 is assembled in the sealed, watertight manner, as described below. In some implementations, locking security tab 124 includes an aperture 126 extending therethrough, which is similarly configured to align with aperture 127 in security tab 125. If desired, upon connection, a lock wire (not shown) may be inserted through apertures 126 and 127 and secured to prevent disconnection of plug component 102 from socket component 104.

As shown in FIG. 3B, rearward end 122 of primary housing 106 includes a reduced outside diameter relative to body 114 and includes a threaded outer surface 128 for engaging a correspondingly threaded inner surface 130 in a forward end 132 of base housing 108, as described below. During assembly of plug component assembly 102, primary housing 106 may be coupled to base housing 108 via threaded surfaces 128 and 130.

As shown in the figures, central lumen 116 of primary housing 106 includes a forward portion 132, an intermediate portion 134, and a rearward portion 136. Forward portion 132 has an inside diameter that forms a cavity 133 configured to receive a portion of socket component assembly 104, as described below.

Consistent with implementations described herein, forward portion 132 of primary housing 106 includes one or more locking features for engaging corresponding features in socket component assembly 104. In particular, as shown in FIGS. 1A and 3B, forward portion 132 may include one or more L-shaped notches 138 configured to receive corresponding bayonet features in socket component assembly 104 in a twist to lock manner, as described below. L-shaped notches 138 include an open end for receiving a bayonet feature. In one implementation, an inner portion of L-shaped notch 138 may have an increased width (indicated at dimension d1 in Detail 1 of FIG. 4) resulting in a lip 139 for capturing the bayonet feature and preventing or minimizing unintended unlocking of the connector. As shown in FIG. 3C, the outer surface of forward end 118 may further include indicia that corresponds to the location of the open end of each L-shaped notch 138 for assisting users in locating the notches during connection of plug component assembly 102 to socket component assembly 104. In some implementations, the inner portion of L-shaped notch 138 may further include a rearwardly angled configuration, such that rotation of the bayonet feature of socket component assembly 104 causes socket component assembly 104 to advance within cavity 133, thus compressingly engaging seal member 112.

Intermediate portion 134 has an inside diameter reduced from that of forward portion 132 and configured to seatingly engage a portion of plug assembly 110, as described below. As shown in FIGS. 3B and 3D, a shoulder portion 135 is formed at the interface of forward portion 132 and intermediate portion 134. Rearward portion 136 has an inside diameter reduced from that of intermediate portion 134 and configured to receive plug assembly 110, as described below.

In one implementation, as shown in FIGS. 3A-3D, plug component base housing 108 include an elongated, generally cylindrical body 140 having a central lumen 141 extending therethrough. Consistent with implementations described herein, base housing 108 may be made from plastic, metal, or any suitable material or combination of materials. In one specific embodiment, primary housing 106 is molded of a High Density Polyethylene (HDPE) material, although other suitable materials and manufacturing techniques may be used.

As shown, plug component base housing 108 includes forward end 142 for engaging rearward end 122 of plug component primary housing 106 and a rearward end 144 configured to accommodate an electrical cable 146 extending therethrough. As shown most clearly in FIGS. 3B and 3D, internal surface of forward end 142 includes threaded inner surface 130 for engaging correspondingly threaded inner surface 128 in a rearward end 122 of primary housing 106, as described above. During assembly of plug component assembly 102, primary housing 106 may be coupled to base housing 108 via threaded surfaces 128 and 130.

As shown, rearward end 144 of base housing 108 may have a reduced inside and outside diameter relative to that of forward end 142, thus forming a potting chamber 148 therein within central lumen 141. In one implementation, the inside diameter of rearward end 144 may be sized to be larger than an outside diameter of cable 146 to form a gap 149 to accommodate injection of a potting or sealing material, such as a urethane adhesive/potting material within potting chamber 148, as shown in FIGS. 1B and 2B. In such an implementation, during assembly of plug component assembly 102, following insertion/seating of plug assembly 110 within primary housing 106, as described below, and following threaded connection of base housing 108 to primary housing 106, the potting material may be injected into potting chamber 148 via gap 149.

Plug assembly 110 includes a plug housing 150 and a conductor assembly 152. Consistent with implementations described herein, plug housing 150 includes an elongated, generally cylindrical body having a forward end 154, an intermediate portion 156, and a rearward end 158. Consistent with implementations described herein, plug housing 150 may molded around conductor assembly 152 during manufacture. In other embodiments, plug housing 150 may be generally tubular and may be configured to receive conductor assembly 152 and forward end of electrical cable 146 therein. In any event, plug housing 150 may be made from suitable material or combination of materials, such as a plastic, polymeric, or rubber material.

As shown, in FIGS. 3B, 3D, and 4, forward end 154 of plug housing 150 generally includes a first portion 160 having an outside diameter configured to correspond to the inside diameter of intermediate portion 134 of plug component primary housing 106, generally described above. Forward end 154 further includes a second portion 162 which extends forwardly from first portion 160. As shown, second portion 162 includes a lip portion 164 at its forward edge. Lip portion 164 is configured to extend beyond the outside diameter of second portion 162, for example, by a distance d2, as shown in Detail 2 of FIG. 4, to capture and retain seal member 112 in abutting relationship with shoulder portion 135. Such an arrangement provides an axial seal between plug component primary housing 106 and socket component primary housing 166, when the plug component assembly 102 is coupled to socket component assembly 104.

In one exemplary implementation, seal member 112 includes a resilient O-ring formed of, for example, nitrile, neoprene, ethylene propylene rubber, silicone, or polytetrafluoroethylene. Seal member 112 may be sized to have an inside diameter substantially similar to outside diameter of second portion 162 and an outside diameter substantially similar to the inside diameter of cavity 133 in forward portion 132 of plug component primary housing 106.

As shown in FIG. 4, intermediate portion 156 of plug housing 150 includes a reduced outside diameter relative to forward end 154 and is configured to engage rearward end 122 of primary housing 106, as shown in FIG. 4. Rearward end 158 of plug housing 150 extends from, intermediate portion 156. During assembly, rearward end 158 is configured to project into potting chamber 148, such that the potting material flows around rearward end 158, effectively securing and sealing plug housing 150 to primary housing 106 and base housing 108.

Consistent with implementations described herein, conductor assembly 152 includes a conductor plug 165 for mating with a corresponding receptacle (or jack) in socket component assembly 104, as described below. In some embodiments, conductor plug 165 includes a three conductor plug configuration, such as a 3.5 millimeter (mm) tip, ring, and sleeve (TRS) configuration, sometimes referred to as an auxiliary or audio plug. In other implementations, different plug configurations may be used (e.g., a 4 conductor, tip, ring, ring, and sleeve (TRRS) configuration), a pogo pin connector, etc.). As described briefly above, conductor assembly 152 may be received within plug housing 150 or plug housing 150 may be molded about conductor assembly 152 during manufacture of plug component assembly 102.

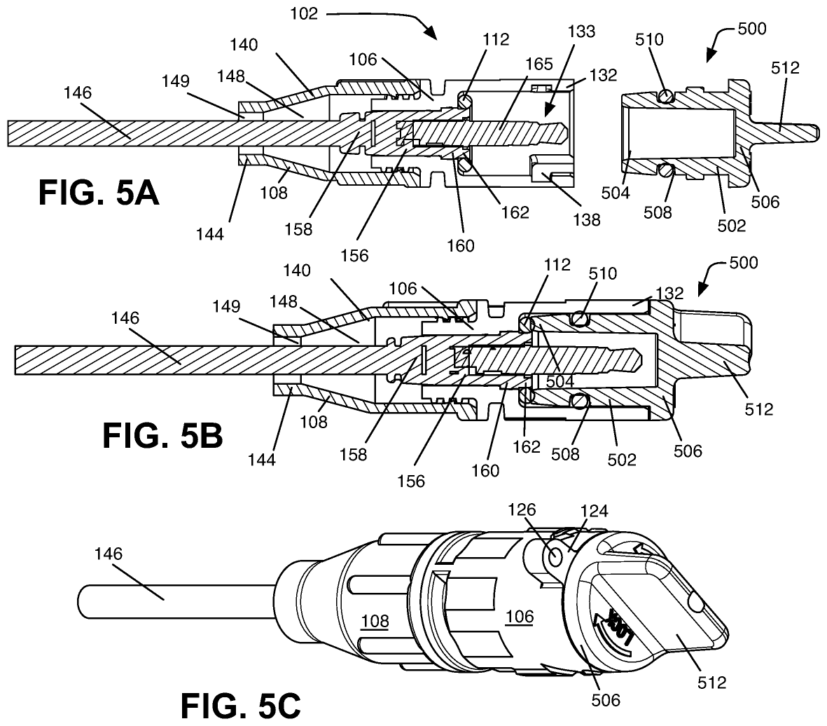

FIGS. 5A, 5B, and 5C are exploded cross-sectional, assembled cross-sectional, and isometric views, respectively, of plug component assembly 102 and an associated dust plug 500. As shown, dust plug 500 includes a generally tubular plug body 502 having an open rearward portion 504 and a closed forward portion 506. Rearward portion 504 is generally sized to fit snugly within forward portion 132 of central lumen 116 in primary housing 106. Consistent with implementations described herein, the outer surface of rearward portion 504 includes a notch or annular groove 508 for receiving a seal member 510 therein. As shown in FIGS. 5A and 5B, seal member 510 may include an O-ring or similar sealing member.

Forward portion 506 includes on outside diameter substantially similar to that of primary housing 106, such that when dust plug 500 is installed within primary housing 106, forward portion 506 mates with forward end 118 of plug component primary housing 106. Forward portion 506 may include a grasping tab 512 which projects forwardly from forward portion 506, to assist in installing and removing dust plug 500.

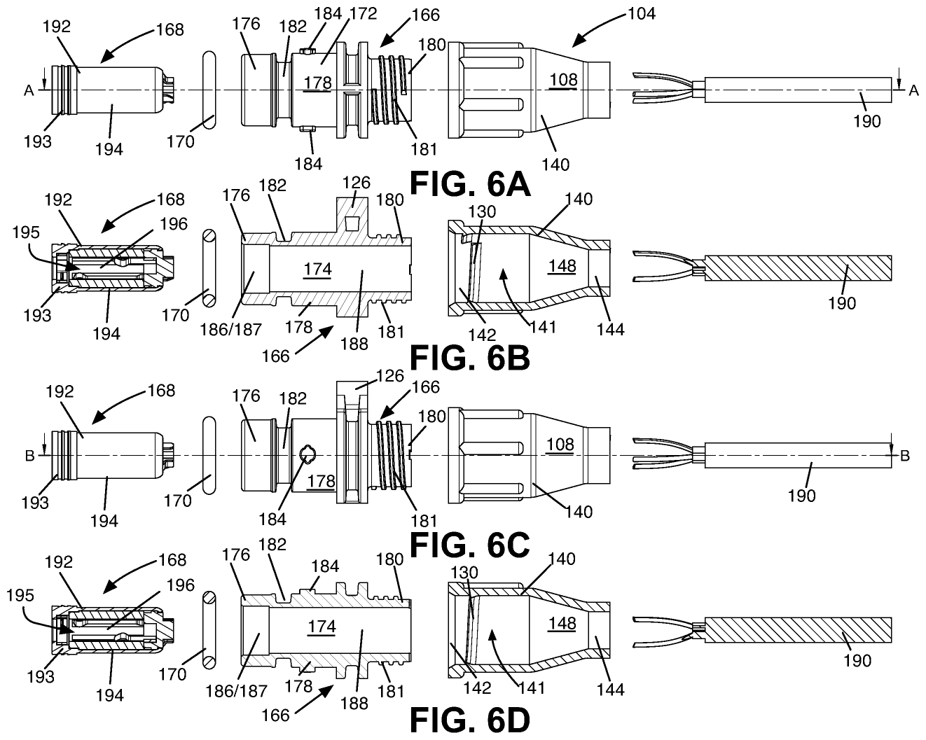

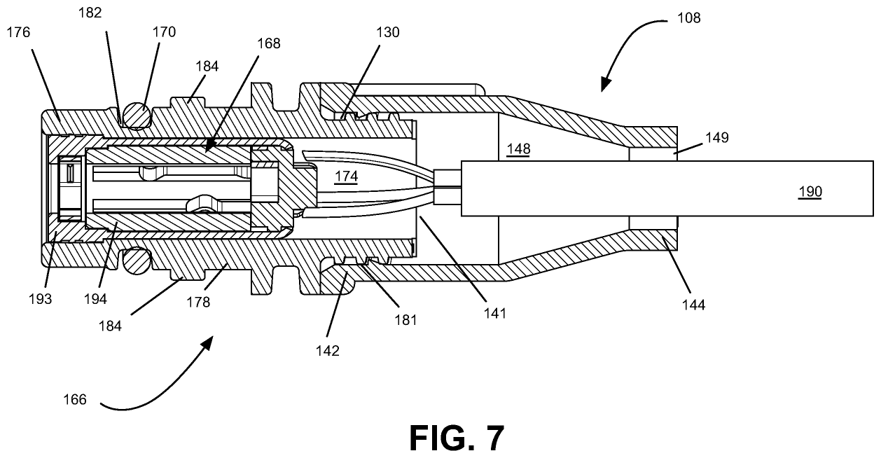

FIGS. 6A-6D illustrate socket component assembly 104 in an exploded first plan view, an exploded first cross-sectional view, an exploded second plan view (taken 90° relative to the first plan view), and an exploded second cross-sectional view, respectively. FIG. 7 is a cross-sectional view of socket component assembly 104 in a pre-coupled configuration.

As shown in the various figures and, in particular, FIGS. 6A-6D, socket component assembly 104 includes a primary housing 166, base housing 108, a jack assembly 168, and a seal member 170. In one implementation, as shown in FIGS. 6A-6D, socket component primary housing 166 include an elongated, generally cylindrical body 172 having a central lumen 174 extending therethrough. Consistent with implementations described herein, primary housing 166 may be made from plastic, metal, or any suitable material or combination of materials. In one specific embodiment, primary housing 166 is molded of a glass fiber reinforced polybutylene terephthalate (PBT) material, although other suitable materials and manufacturing techniques may be used. Primary housing 166 includes a forward end 176 for engaging a corresponding forward end of plug component assembly 102 during coupling of plug component assembly 102 to socket component assembly 104 (described below), an intermediate portion 178, and a rearward end 180 configured to engage base housing 108. As shown most clearly in FIGS. 1B, 2B, 6B, and 6C, forward end 176 may include a locking security tab 125 which projects radially from body 172 and is configured to align with a similar security tab 124 on plug component assembly 104 when connector assembly is assembled in the sealed, watertight manner, as described briefly above.

As shown in FIGS. 6A-6D, outer surface of intermediate portion 178 includes an annular notch or groove 182 for receiving a seal member 170 therein. As shown in FIGS. 5A and 5B, seal member 170 may include an O-ring or similar sealing member. In one exemplary implementation, seal member 170 includes a resilient O-ring formed of, for example, nitrile, neoprene, ethylene propylene rubber, silicone, or polytetrafluoroethylene. As shown in FIGS. 7A and 7B, seal member 170 may be sized to have an inside diameter substantially similar to outside diameter of groove 182 and an outside diameter slightly larger than an outside diameter of forward portion 176 of socket component primary housing 166. During coupling of plug component assembly 102 to socket component assembly 104, seal member 170 may form a radial seal between socket component primary housing 166 and plug component primary housing 106. More specifically, seal member 170 positioned within groove 182 may sealingly engage forward portion 132 of central lumen 116 in plug component primary housing 106 in a radially compressive manner.

As shown in the figures, outer surface of intermediate portion 178 may further include one or more bayonet features 184, which project radially from body 172. As described briefly above, bayonet features 184 may be sized and located to correspond with L-shaped notches 138 in plug component primary housing 106. As shown, in one implementation, body portion 172 may include two bayonet features 184 positioned on opposite sides of body portion 172. In some implementations, one or both of bayonet features 184 may have a generally cylindrical configuration. In other implementations, such as shown in FIG. 6C, bayonet features 184 may include a cylindrical configuration with opposing wing portions.

As shown in FIG. 6B, rearward end 180 of primary housing 166 includes a reduced outside diameter relative to body 172 and includes a threaded outer surface 181 for engaging threaded inner surface 130 in a forward end 132 of base housing 108, as described above. During assembly of socket component assembly 104, primary housing 166 may be coupled to base housing 108 via threaded surfaces 181 and 130.

As shown in the figures, central lumen 174 of socket component primary housing 166 includes a forward portion 186, and a main portion 188. Forward portion 186 has an inside diameter that forms a cavity 187 configured to receive a portion of jack assembly 168, as described below. In particular, a shoulder portion 189 is formed at the interface of forward portion 186 and main portion 188. Main portion 188 has an inside diameter reduced from that of intermediate portion 134 and configured to receive jack assembly 168, as described below.

In one implementation, as shown in FIGS. 6A-B, base housing 108 of socket component assembly 104 is formed identically to that of plug component assembly 102. Accordingly, similar to plug component assembly 102, forward end 132 of base housing 108 engages rearward end 180 of plug component primary housing 106 and a rearward end 144 is configured to accommodate an electrical cable 190 extending therethrough. As shown most clearly in FIGS. 6B and 6D, threaded inner surface 130 in forward end 132 of base housing 108 is configured to engage threaded outer surface 181 in a rearward end 180 of primary housing 166, as described above. During assembly of socket component assembly 104, primary housing 166 may be coupled to base housing 108 via threaded surfaces 181 and 130.

As with plug component assembly 102, described above, rearward end 144 of socket component base housing 108 may also have a reduced inside and outside diameter relative to that of forward end 132, to forming potting chamber 148. During assembly of socket component assembly 104, following insertion/seating of jack assembly 168 within primary housing 166, as described below, and following threaded connection of base housing 108 to primary housing 166, potting material may be injected into potting chamber 148 via gap 149.

Jack assembly 168 includes a jack housing 192 and a conductor assembly 195. Consistent with implementations described herein, jack housing 192 includes an elongated, generally cylindrical body having a forward end 193 and a main portion 194. Jack housing 192 may be molded around conductor assembly 195 during manufacture. In other embodiments, jack housing 192 may be generally tubular and may be configured to receive conductor assembly 195 therein. In any event, jack housing 192 may be made from suitable material or combination of materials, such as a plastic, polymeric, or rubber material.

As shown, in FIGS. 6B, 6D, and 7, forward end of 193 of jack housing 192 generally includes an outside diameter configured to correspond to the inside diameter of cavity 187 in forward portion 186 of socket component primary housing 166, generally described above. Main portion 194 of jack housing 192 includes a reduced outside diameter relative to forward end 192 and is configured to engage main portion 188 of central lumen 174 in socket component primary housing 166, as shown in FIG. 7.

Consistent with implementations described herein, conductor assembly 195 includes a conductor jack 196 for mating with corresponding plug 165 in plug component assembly 102, as described above. In some embodiments, conductor jack 196 includes a three-conductor jack configuration, such as a 3.5 mm TRS jack configuration. In other implementations, different plug configurations may be used (e.g., a 4 conductor TRRS, a pogo pin connector, etc.). As described briefly above, conductor assembly 195 may be received within jack housing 192 or jack housing 192 may be molded about conductor assembly 195 during manufacture of socket component assembly 104.

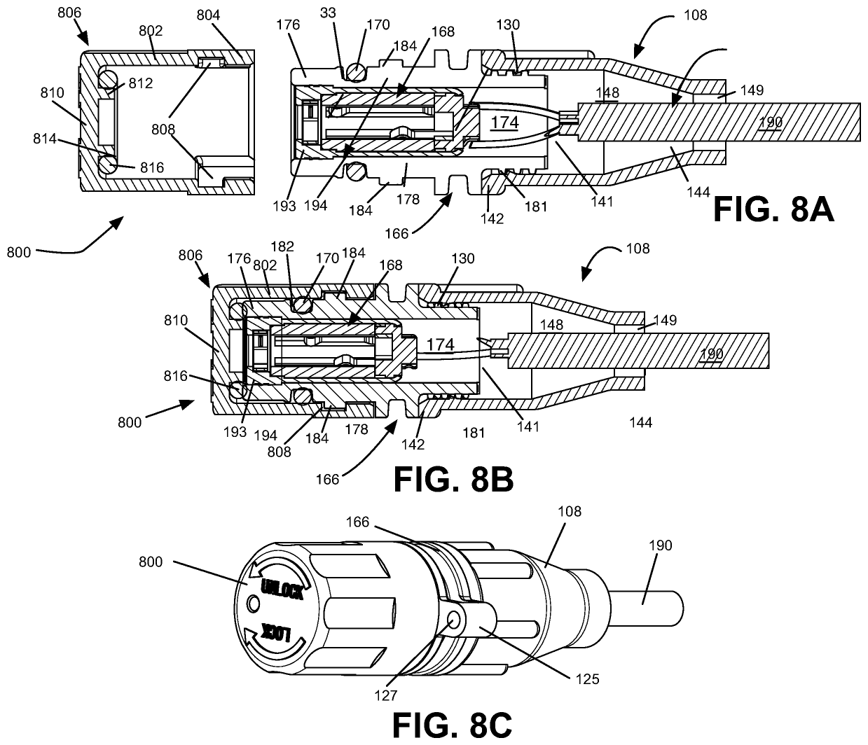

FIGS. 8A and 8B are cross-sectional views of socket component assembly 104 and an associated dust cap 800 in exploded and assembled configurations, respectfully. FIG. 8C is an isometric view of socket component assembly 104 with installed dust cap 800. As shown, dust cap 800 includes a generally tubular plug body 802 having an open rearward portion 804 and a closed forward portion 806. Rearward portion 804 is generally sized to fit snugly over the outer surface of primary housing 166.

Consistent with implementations described herein, rearward portion 804 of dust cap 800 includes one or more locking features for engaging bayonet features 184 in socket component assembly 104. In particular, rearward portion 804 may include one or more L-shaped notches 808 configured to receive corresponding bayonet features 184 in a manner similar to that described above. L-shaped notches 808 each include an open end for receiving a bayonet feature 184. In one implementation, an inner portion of each L-shaped notch 808 may have a lip formed thereon for capturing the bayonet feature and preventing or minimizing unintended unlocking of the connector.

Consistent with implementations described herein, closed forward portion 806 includes closed end 810 and a tubular second portion 812 which extends rearwardly from closed end 810. As shown, second portion 812 includes a lip portion 814 at its rearward edge. Lip portion 814 is configured to extend slightly beyond the outside diameter of second portion 812, for example, by distance d2, as shown in detail 2 of FIG. 4 in relation to plug housing 150 above. In this manner, lip portion 814 is configured to capture and retain a seal member 816 in abutting relationship with closed end 810.

Seal member 816 includes a resilient O-ring formed of, for example, nitrile, neoprene, ethylene propylene rubber, silicone, or polytetrafluoroethylene. As shown, seal member 816 may be sized to have an inside diameter substantially similar to outside diameter of second portion 812 and an outside diameter substantially similar to the inside diameter of open rearward portion 804.

A waterproof connector assembly is provided for connecting a first electrical cable to a second electrical cable. The connector assembly includes a plug component coupled to the first electrical cable and a socket component coupled to the second electrical cable. The plug component comprises a plug component primary housing and the socket component comprises a socket component primary housing. The plug component primary housing comprises a cavity for receiving at least a portion of the socket component primary housing. The plug component comprises a first seal member for providing an axial seal between the plug component primary housing and the socket component primary housing when in a coupled configuration. The socket component comprises a second seal member for providing a radially compressive seal between the plug component primary housing and the socket component primary housing when in a coupled configuration.

In some implementations, the connector assembly further includes one or more locking mechanisms for facilitating secure connection of the plug component of the connector to the socket component of the connector. In one implementation, the respective plug component and socket component primary housings are provided with locking tabs which align upon connection and which may be secured together. In other implementations, the connector may be provided with a twist to lock mechanism for facilitating a secure and sealed coupling between the plug and socket components. In this manner, the waterproof connector assembly provides a simplified connector, eliminating alignment challenges of threaded connectors and complexities of some three-piece waterproofing designs. The waterproof connector assembly may be used to connect an outdoor device, such as a water meter, to an antenna or transmitter.

The foregoing description of implementations provides illustration and description but is not intended to be exhaustive or to limit the invention to the precise form disclosed. Modifications and variations are possible in light of the above teachings or may be acquired from practice of the invention.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions are performed, etc., but are used merely as labels to distinguish one claim element having a certain name from another element having a same name (but for use of the ordinal term) to distinguish the claim elements. Similarly, use of directional terms, such as “rearward,” “forward,” etc. does not connote any absolute directionality and are merely used to described relative locations or positions with respect to other components.

No element, act, or instruction used in the description of the present application should be construed as critical or essential to the invention unless explicitly described as such. Also, as used herein, the articles “a,” “an,” and “the” are intended to include one or more items. Further, the phrase “based on” is intended to mean “based, at least in part, on” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

With reference to the use of the words “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

All structural and functional equivalents to the elements of the various aspects set forth in this disclosure that are known or later come to be known to those of ordinary skill in the art are expressly incorporated herein by reference and are intended to be encompassed by the claims. No claim element of a claim is to be interpreted under 35 U.S.C. § 112(f) unless the claim element expressly includes the phrase “means for” or “step for.”

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A connector assembly for connecting a first electrical cable to a second electrical cable, the connector assembly comprising:
a first component assembly comprising:
a first component primary housing;
a first conductor assembly; and
a first seal member;
a second component assembly comprising:
a second component primary housing;
a second conductor assembly; and
a second seal member,
wherein the first component primary housing includes a first lumen therethrough configured to receive the first conductor assembly,
wherein the second component primary housing includes a second lumen therethrough configured to receive the second conductor assembly,
wherein the first lumen comprises a cavity for receiving the second component primary housing therein when the second component is coupled to the first component,
wherein the first seal member provides an axial seal between the first component primary housing and the second component primary housing when the second component primary housing is seated within the first component primary housing, and
wherein the second seal member provides a radial seal between the first component primary housing and the second component primary housing when the second component primary housing is seated within the first component primary housing.

2. The connector assembly of claim 1,
wherein the first conductor assembly comprises a plug assembly, and
wherein the second conductor assembly comprises a jack assembly configured to receive at least a portion of the plug assembly therein the when the second component primary housing is seated within the first component primary housing.

3. The connector assembly of claim 2,
wherein the plug assembly comprises a tip, ring, and sleeve (TRS) plug, and
wherein the jack assembly comprises a TRS jack.

4. The connector assembly of claim 1,
wherein the cavity in the first primary housing comprises a first inside diameter,
wherein the first lumen comprises an intermediate portion adjacent the cavity,
wherein the intermediate portion comprises a reduced diameter relative to the first inside diameter of the cavity to form a shoulder portion;
wherein the first seal member provides the axial seal between the shoulder portion and the second component primary housing when the second component primary housing is seated within the cavity of the first component primary housing.

5. The connector assembly of claim 4,
wherein the first conductor assembly comprises a plug housing having a forward end and an intermediate portion,
wherein a first portion of the forward end is configured for receipt within the intermediate portion of the first lumen, and
wherein a second portion of the forward end is configured to extend beyond the shoulder portion and into the cavity.

6. The connector assembly of claim 5,
wherein the first seal member comprises a first O-ring,
wherein the second portion of the forward end of the plug housing includes a forward edge having a lip portion formed therein,
wherein the lip portion is configured to retain the first O-ring within the cavity and adjacent the shoulder portion.

7. The connector assembly of claim 1,
wherein the first component primary housing comprises a rearward portion adjacent the intermediate portion;
wherein the first component assembly further comprises:
a base housing having a second lumen therethrough,
wherein the base housing includes a forward end configured to couple with the rearward portion of the first component primary housing and a rearward end configured to accommodate an electrical cable coupled to the first conductor assembly.

8. The connector assembly of claim 7,
wherein the rearward portion of the first component primary housing comprises a first threaded surface, and
wherein the forward end of the base housing comprises a second threaded surface configured to engage the first threaded surface.

9. The connector assembly of claim 7,
wherein the second lumen comprises a potting chamber for receiving a potting material therein,
wherein the potting material is configured to engage and secure at least portions of: the reward portion of the first primary housing, the first conductor assembly, and the electrical cable.

10. The connector assembly of claim 1,
wherein the cavity in the first component primary housing comprises a first locking feature for engaging a corresponding second locking feature in the second component primary housing.

11. The connector assembly of claim 10,
wherein the first locking feature comprises one or more L-shaped notches formed in an inner surface of the cavity,
wherein the second locking feature comprises one or more bayonet features that project outwardly from the second component primary housing,
wherein the one or more L-shaped notches each comprise an open end for receiving the one or more bayonet features when the second component primary housing is received with in the cavity of the first component primary housing,
wherein the second component primary housing is locked to the first component primary housing by pressing and rotating second component primary housing relative to first component primary housing, causing the one or more bayonet features to travel within the one or more L-shaped notches.

12. The connector assembly of claim 11,
wherein an inner portion of at least one of the L-shaped notches comprises a lip for capturing the bayonet feature when the bayonet feature is fully seated within the at least one L-shaped notch.

13. The connector assembly of claim 11,
wherein the inner portion of at least one L-shaped notch has an angled configuration, such that movement of the bayonet feature along the at least one L-shaped notch causes the second component primary housing to advance within the cavity in the first component primary housing, compressingly engaging the first seal member.

14. The connector assembly of claim 1,
wherein the second component primary housing includes a forward end, an intermediate portion, and a rearward portion,
wherein the intermediate portion comprises an annular groove formed about a periphery thereof,
wherein the second seal member is provided within the annular groove.

15. The connector assembly of claim 14, wherein the second seal member comprises a second O-ring.

16. The connector assembly of claim 14,
wherein the intermediate portion comprises a second locking feature for engaging a corresponding first locking feature in the first component primary housing.

17. The connector assembly of claim 16,
wherein the second locking feature comprises one or more bayonet features that project outwardly from the intermediate portion of the second component primary housing,
wherein the first locking feature comprises one or more L-shaped notches formed in an inner surface of the cavity in the first component primary housing,
wherein the second component primary housing is locked to the first component primary housing by pressing and rotating second component primary housing relative to first component primary housing, causing the one or more bayonet features to travel within the one or more L-shaped notches.

18. The connector assembly of claim 17, wherein the one or more bayonet features comprise two bayonet features positioned on opposite surfaces of the second component primary housing.

19. The connector assembly of claim 17, wherein the one or more bayonet features are positioned rearwardly of the annular groove.

20. The connector assembly of claim 1,
wherein the second primary housing comprises a rearward portion;
wherein the second component assembly further comprises:
a base housing having a second lumen therethrough,
wherein the base housing includes a forward end configured to couple with the rearward portion of the second primary housing and a rearward end configured to accommodate an end of the first electrical cable coupled to the first conductor assembly,
wherein the second lumen comprises a potting chamber for receiving a potting material therein,
wherein the potting material is configured to engage and secure at least portions of: the reward portion of the first primary housing, the first conductor assembly, and the first electrical cable.

21. A connector assembly for connecting a first electrical cable to a second electrical cable, the connector assembly comprising:
a first component assembly comprising:
a first component primary housing configured to receive a first conductor assembly; and
a first seal member; and
a second component assembly comprising:
a second component primary housing configured to receive a second conductor assembly; and
a second seal member,
wherein the first component primary housing comprises a cavity for receiving the second component primary housing therein when the second component assembly is coupled to the first component assembly,
wherein the first seal member provides an axial seal between the first component primary housing and the second component primary housing and the second seal member provides a radial seal between the first component primary housing and the second component primary housing when the second component primary housing is seated within the cavity.

22. The connector assembly of claim 21,
wherein the first component primary housing comprises a first lumen extending therethrough, wherein a forward portion of the first lumen includes the cavity,
wherein the cavity in the first primary housing comprises a first inside diameter,
wherein the first lumen comprises an intermediate portion adjacent the cavity,
wherein the intermediate portion comprises a reduced diameter relative to the first inside diameter of the cavity to form a shoulder portion, and
wherein the first seal member provides the axial seal between the shoulder portion and the second component primary housing when the second component primary housing is seated within the cavity of the first component primary housing.

23. The connector assembly of claim 22,
wherein the first conductor assembly is received within the intermediate portion of the first lumen and includes a forward end that projects into the cavity,
wherein the first seal member comprises a first O-ring that engages the shoulder portion and the forward end of the first conductor assembly.

24. The connector assembly of claim 23,
wherein the forward end of the first conductor assembly includes a forward edge having a lip portion formed therein,
wherein the lip portion is configured to retain the first O-ring within the cavity and adjacent the shoulder portion.

25. The connector assembly of claim 21,
wherein the cavity in the first component primary housing comprises a first locking feature for engaging a corresponding second locking feature in the second component primary housing.

26. The connector assembly of claim 25,
wherein the first locking feature comprises one or more L-shaped notches formed in an inner surface of the cavity,
wherein the second locking feature comprises one or more bayonet features that project outwardly from the second component primary housing,
wherein the one or more L-shaped notches each comprise an open end for receiving the one or more bayonet features when the second component primary housing is received with in the cavity of the first component primary housing,
wherein the second component primary housing is locked to the first component primary housing by pressing and rotating second component primary housing relative to first component primary housing, causing the one or more bayonet features to travel within the one or more L-shaped notches.

27. The connector assembly of claim 26,
wherein an inner portion of at least one of the L-shaped notches comprises a lip for capturing the bayonet feature when the bayonet feature is seated within the at least one L-shaped notch.

28. The connector assembly of claim 26,
wherein the inner portion of at least one L-shaped notch has an angled configuration, such that movement of the bayonet feature along the at least one L-shaped notch causes the second component primary housing to advance within the cavity in the first component primary housing, compressingly engaging the first seal member.

29. The connector assembly of claim 21,
wherein the second component primary housing includes a forward end, an intermediate portion, and a rearward portion,
wherein the intermediate portion comprises an annular groove formed about a periphery thereof,
wherein the second seal member is provided within the annular groove.

30. The connector assembly of claim 29, wherein the second seal member comprises a second O-ring.

31. The connector assembly of claim 29,
wherein the intermediate portion comprises a second locking feature for engaging a corresponding first locking feature in the first component primary housing.

32. The connector assembly of claim 31,
wherein the second locking feature comprises one or more bayonet features that project outwardly from the intermediate portion of the second component primary housing,
wherein the first locking feature comprises one or more L-shaped notches formed in an inner surface of the cavity in the first component primary housing,
wherein the second component primary housing is locked to the first component primary housing by pressing and rotating second component primary housing relative to first component primary housing, causing the one or more bayonet features to travel within the one or more L-shaped notches.

33. The connector assembly of claim 32, wherein the one or more bayonet features comprise two bayonet features positioned on opposite surfaces of the second component primary housing.

34. The connector assembly of claim 32, wherein the one or more bayonet features are positioned rearwardly of the annular groove.
